(19) United States
(12) Patent Application Publication
(10) Pub. No.: US 2006/0001737 A1
(43) Pub. Date: Jan. 5, 2006

(54) Video conference arrangement

(76) Inventors: Thomas Patrick Dawson, Escondido, CA (US); Priyan Gunatilake, San Diego, CA (US); David Boyden, Escondido, CA (US); Takaaki Ota, San Diego, CA (US); Christopher Jensen Read, San Diego, CA (US)

Correspondence Address: MILLER PATENT SERVICES, 2500 DOCKERY LANE, RALEIGH, NC, 27606, US

(21) Appl. No.: 10/883,089

(22) Filed: Jul. 1, 2004

(51) Int. Cl. H04N 7/14

(52) U.S. Cl. 348/14.08; 348/14.04

(57) ABSTRACT

A videoconferencing method consistent with certain embodiments involves receiving a video stream via a broadband network connection at a television display to display a remote party's inbound video information. A video stream is transmitted via a wireless cellular telephone's camera to the remote party to provide outbound video information. Inbound audio is received from the remote party via the broadband network connection at the television display and playing the audio using the television display's audio circuits. Outbound audio is transmitted to the remote party via the wireless cellular telephone's audio circuits. This abstract is not to be considered limiting, since other embodiments may deviate from the features described in this abstract.

### BACKGROUND

Videoconferencing has become a widely available tool for permitting users to communicate both visually and audibly over long distances for both business and personal applications. Generally, in a videoconference environment, a dedicated video display that is large enough for multiple users to easily view is used, along with a dedicated microphone and audio amplification equipment.

### BRIEF DESCRIPTION OF THE DRAWINGS

Certain illustrative embodiments illustrating organization and method of operation, together with objects and advantages may be best understood by reference detailed description that follows taken in conjunction with the accompanying drawings in which:

FIG. 1 is a block diagram of a videoconferencing system consistent with certain embodiments of the present invention.

FIG. 2 is a flow chart of a first embodiment of a videoconferencing call initiation process consistent with certain embodiments of the present invention.

FIG. 3 is a flow chart of a second embodiment of a videoconferencing call initiation process consistent with certain embodiments of the present invention.

FIG. 4 is a flow chart of a videoconferencing call receipt process consistent with certain embodiments of the present invention.

FIG. 5 is a flow chart of a process for terminating a videoconference call consistent with certain embodiments of the present invention.

FIG. 6 is a block diagram of a television system suitable for providing videoconferencing services consistent with certain embodiments of the present invention.

### DETAILED DESCRIPTION

While this invention is susceptible of embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically. The term “program”, as used herein, is defined as a sequence of instructions designed for execution on a computer system. A “program”, or “computer program”, may include a subroutine, a function, a procedure, an object method, an object implementation, in an executable application, an applet, a servlet, a source code, an object code, a shared library/dynamic load library and/or other sequence of instructions designed for execution on a computer system. The term “remote” is used herein to identify a location of a party involved with a “local” user in a videoconference. The degree of remoteness is not relevant, since a videoconference could be carried out between parties in adjacent rooms (or even the same room) or thousands of miles away.

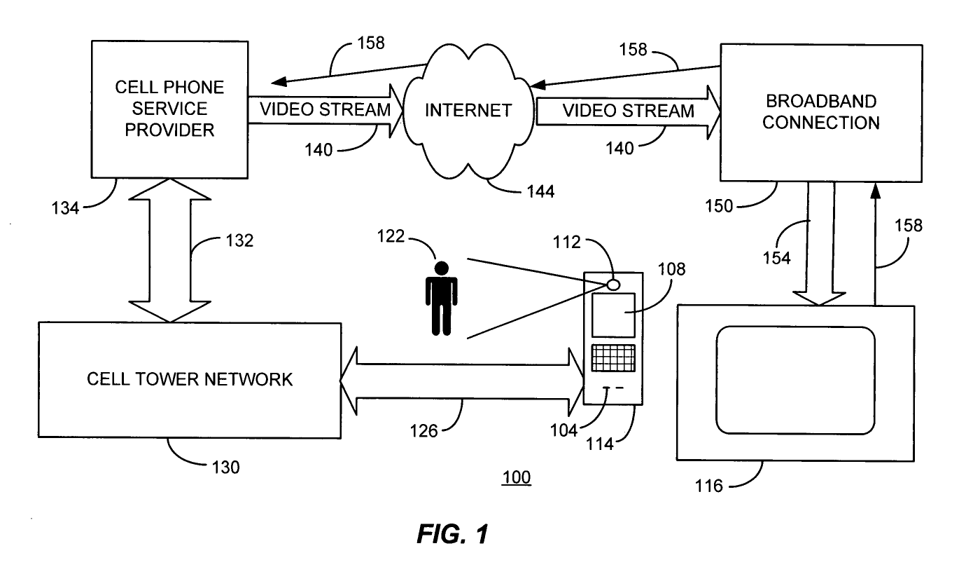

Turning now to FIG. 1, a videoconferencing system 100 consistent with certain embodiments is depicted. In this system 100, a user's camera-enabled wireless (e.g., cellular) telephone 104 (i.e., a wireless telephone with a built-in camera for capturing still and/or moving video images) is utilized as an input device for the video conference. Such devices are currently available from several manufacturers and utilize a small video screen 108 to display images either from video telephone calls or images captured on the telephone's built-in camera 112. Audio is captured in a conventional manner using the telephone's audio circuits including microphone 114. In the current embodiment, while images can be viewed on the telephone's display 108 in a conventional fashion, the camera 112 is used as an input device for images that are displayed on a remote video display during a videoconference. A television display 116 is used to display video that is captured at the remote site or sites involved in the videoconference, in addition to preferably functioning as a conventional television receiver.

It should be noted that system 100 depicts only one side of a videoconference. The other side can be similarly outfitted, or can be realized within a telephone, video conference system or personal computer based videoconference system. When images of a person or persons such as 122 are captured by the camera 112 of telephone 112, they are transmitted to the remote party via the cellular telephone network using a two way communication channel 126 through cell tower network 130. The video can then be delivered to the recipient either via the cell tower network 130 or via connection 132 through other connections provided by the cell phone service provider 134.

Video data from the remote party, regardless of how it is received from the remote party at the service provider 134, are then sent as a video stream 140 via a high speed data network such as the Internet 144. The video stream 140 emerges from the network 144 to a broadband connection 150 (e.g., a Digital Subscriber Line (DSL) modem, high speed analog modem or an Integrated Services Digital Network (ISDN) modem, or a digital telephone line adapter, etc.) that in turn provides a stream of video data 154 to television display 116. Video stream 140 may also carry audio for the videoconference that is played over the television's audio circuits. A back channel 158 is also depicted to provide for the television or other control device to supply control information relating to the videoconference call to the cell phone service provider 134.

Thus, a videoconference system consistent with certain embodiments has a camera-enabled wireless telephone that transmits video images to a remote location using the telephone's camera and transmits audio signals to the remote location using the telephone's audio circuits. A television which is capable of display of streaming video from the remote location via a broadband network connection is provided.

In another embodiment, a videoconference system has a camera-enabled wireless cellular telephone that transmits video images to a remote location using the telephone's camera and transmits audio signals to the remote location using the telephone's audio circuits. A television capable of display of streaming video from the remote location via a broadband network connection to a cellular telephone service provider is provided. An audio circuit within the television is provided, wherein the streaming video from the remote location includes audio, and wherein the audio is reproduced on the television's audio circuitry. The broadband network connection can be provided, for example, via one of a cable modem or a Digital Subscriber Line (DSL) modem or an Integrated Services Digital Network (ISDN) modem, or a high speed analog modem, or a digital telephone line adapter.

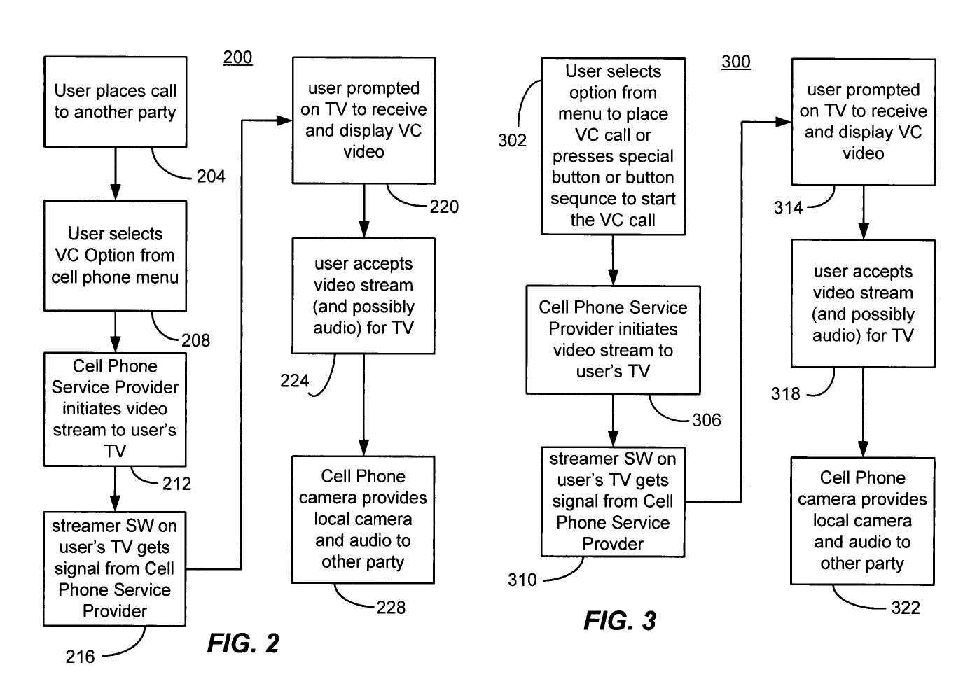

A videoconference telephone call can be placed using the process 200 depicted in the flow chart of FIG. 2. In this embodiment, a user initiates a videoconference by placing a telephone call to another party at 204. At 208, after the call has been initiated, the user selects a videoconference option from a video menu displayed on the user's video display 108, or using a dedicated key on the telephone 104. This sends a message to the cell phone provider 134 that indicates a videoconference call is being implemented. When the cell phone provider 134 receives this message, the cell phone provider 134 initiates a “call” to the user's television 116 (e.g., by sending a message to the Internet Protocol (IP) address designated for the television 116) at 212.

When this “call” is received at television 116, videoconferencing software is enabled at the television 116 including software that enables viewing of streaming video at 216 received via the broadband connection 150. In this embodiment, the user is prompted at 220 to accept or reject the video stream at the television 116 at 220 (in effect, the user “answers” the television, much the same as a user would “answer” a telephone). When the user accepts the video stream for the television 116 at 224, video is enabled for display on the television 116 and the videoconference can proceed with the telephone's camera serving to provide local camera and audio functions that generate audio and video signals transmitted to the remote party.

Thus, in accordance with certain embodiments, A videoconferencing method consistent with certain embodiments involves receiving a video stream via a broadband network connection at a television display to display a remote party's inbound video information. A video stream is transmitted via a wireless cellular telephone's camera to the remote party to provide outbound video information. Inbound audio is received from the remote party via the broadband network connection at the television display and playing the audio using the television display's audio circuits. Outbound audio is transmitted to the remote party via the wireless cellular telephone's audio circuits.

In accordance with other embodiments, a videoconferencing method involves receiving a video stream via a broadband network connection at a television display to display a remote party's inbound video information; and transmitting a video stream via a wireless telephone's camera to the remote party to provide outbound video information.

With reference to FIG. 3, another exemplary process for placing a videoconference call using hardware similar to that described above is depicted as process 300. At 302, the user selects an option from a menu or hard or soft button to place a videoconference call or presses a particular key sequence that enables the initiation of the videoconference call. At 306, the cell phone service provider initiates a call to the user's television. The streamer software of the user's television is enabled at 310 by a signal from the cell phone service provider. At 314, the user is prompted on the television screen or by a special display to receive and display the videoconference video (and possibly play the videoconference audio). If the user accepts the video stream at 318, the videoconference ensues with the wireless telephone's camera providing local capture of video and audio. In this manner, only an Internet capable television (or set top box or other adapter) is needed for videoconferencing. No special camera or microphone is necessary since the cellular telephone is already equipped with that capability.

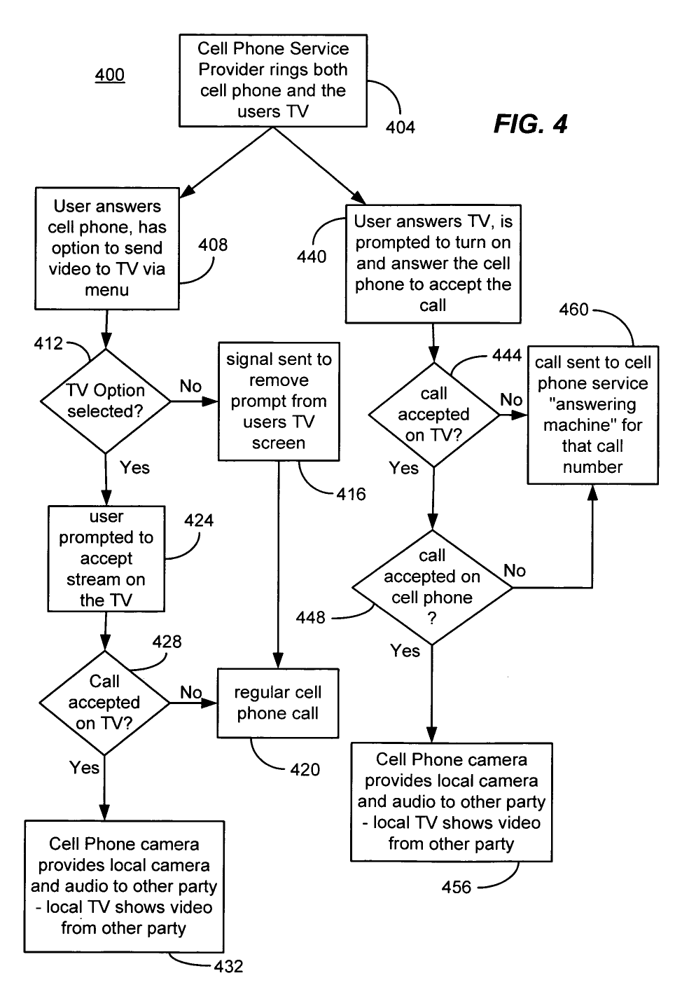

With reference to FIG. 4, a process for receipt of a videoconference call consistent with certain embodiments is depicted as process 400. In this embodiment, a call is initiated by a remote calling party causing the cell phone service provider to “call” both the cell phone and the television associated with the intended recipient at 404. The process can then take one of two major paths from 404. The left path represents the first answer to the call being carried out on the wireless cellular telephone. The right path represents the fist answer to the call being carried out on the television.

Consider first the left path. At 408, the user answers the cell phone and is given a menu option to send video to the television. If the user does not accept the television display option at 412, a signal is sent to the television to clear the prompt appearing at the television to enable the television for videoconference viewing at 416. A regular audio or video telephone call then ensues at 420 using only telephone resources.

If the television option is selected at 412, the user is prompted to accept the video (and possibly audio) stream on the television at 424. If the call is accepted at the television at 428, the cellular telephone camera is situated (e.g., on a stand or otherwise) to utilize the telephone's camera to capture video for the video conference and capture audio for the videoconference and transmit same to the other party at 432. The television is used to display the video and possibly play out the audio of the remote party. In other embodiments, the cellular telephone can also provide the audio from the remote party.

Now consider the right side path. After 404, the user answers the call to the television at 440. The user is prompted to turn on the cellular telephone identified by a particular phone number and accept the call also. If the call is accepted at the television at 444, and the call is accepted at the cellular telephone at 448, then the cellular telephone camera is situated (e.g., on a stand or otherwise) to utilize the telephone's camera to capture video for the video conference at 456 and capture audio for the videoconference and transmit same to the other party. The television is used to display the video and possibly play out the audio of the remote party. In other embodiments, the cellular telephone can also provide the audio from the remote party. If the call is not accepted either at 444 or at 448, the call can be sent to an answering service at 460 or other error handling can be invoked.

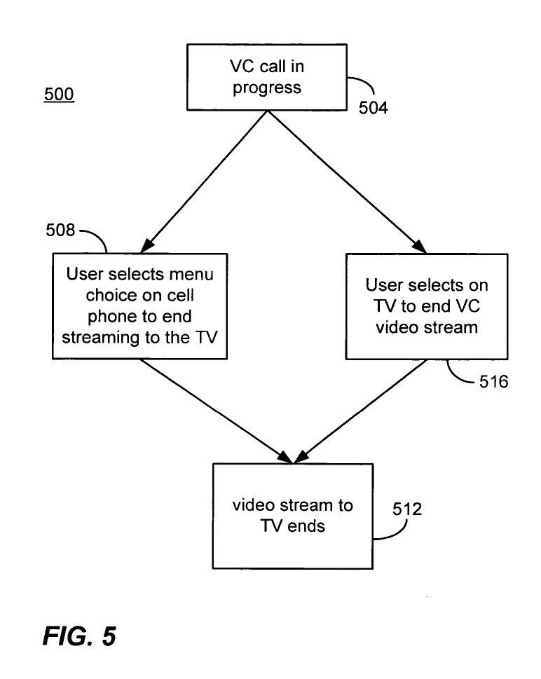

Once a videoconference has been initiated, it can be terminated using the process 500 depicted in FIG. 5. In this process, a videoconference call is in progress at 504. The videoconference call can be terminated by one of two methods shown by the left path and the right path in this illustration. If the left path is taken, control passes to 508 when the user decides to terminate the videoconference session by use of the cellular telephone. To do so, the user invokes a menu on the cellular telephone and makes a menu selection to end the streaming video to the television at 508. The cellular telephone then sends a wireless message to the service provider as a result and the video stream to the television ends at 512. The video conference call can then be terminated if desired by normal procedures for terminating a telephone call using the cellular telephone.

If the right path is taken, control passes to 516 when the user decides to terminate the videoconference session by use of the television. To do so, the user invokes a menu on the television and makes a menu selection to end the streaming video to the television and thus terminate the videoconference at 508. The television sends a message to the service provider as a result via the back channel 158 to terminate the stream, and the video stream to the television ends at 512. The video conference call can then either continue using only the telephone display, or be terminated if desired by normal procedures for terminating a telephone call at the cellular telephone (i.e., the user “hangs up”).

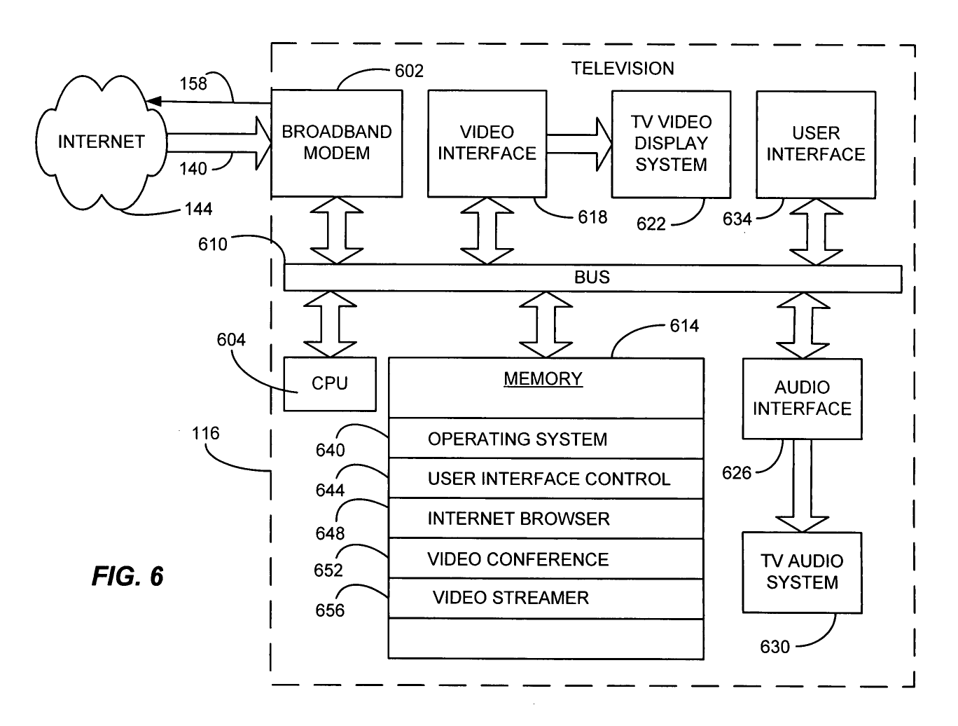

Referring now to FIG. 6, an exemplary television device such as 116 is depicted in relevant part. One skilled in the art will appreciate that this drawing omits functional elements of the television 116 that are not used in certain embodiments of the present invention such as an RF tuner, power supply, etc. It should be noted, however, that the elements depicted in this embodiment with the television device 116 could also be realized in a separate adapter or television set top box without departing from certain embodiments consistent with the present invention.

Television 116, in this example, incorporates an integral broadband modem 602 that can be coupled to the Internet 144 (e.g., a cable modem). Such broadband modem is addressable by, for example, an Internet Protocol address and a MAC address. Modem 602 could also be a separate item of hardware and not integrated within television 116 in other embodiments. Modem 602 transfers data from the Internet to a processor such as computer CPU (Central Processing Unit) 604 via a communication bus 610. In the reverse direction, CPU 604 sends data to locations on the Internet by placing data for the modem 602 on bus 610. Bus 610 also provides a mechanism for CPU 604 to interact with memory 614 in a conventional manner. Memory may incorporate Read Only Memory, as well as Random Access Memory, as well as any other computer storage device (e.g., disc drives, and persistent electronic storage elements, etc.).

CPU 604 can also interact with a video interface 618 in order to send video data to the television's video display system 622. CPU 604 can also interact with an audio interface 626 in order to send audio data to the television's audio system 630. A user interface 634 (e.g., a control panel, key pad, buttons, remote control interface, etc.) is also provided in order for a user to send commands to the CPU in any number of ways including hard coded buttons and switches as well as navigation of on screen menus that can be used to select videoconference options.

The CPU 604 operates under control of computer programs stored in memory 614 that may include an operating system 640 that provides normal functions and services of an operating system. The user interface 634 may be controlled in part or in whole by a user interface control program 644. An Internet browser 648 may also be provided in order to provide navigation to appropriate addresses over the Internet in order, for example, to appropriately contact the cell phone service provider 134 to initiate or carry out a videoconference. Videoconference software 652 may also be stored in memory 614 in order to provide the appropriate control over the videoconference process including, providing of input to the user interface control and the user interface for implementing control (i.e., initiation or teardown) of the video stream. The videoconference software may be implemented as a browser plug-in or in any other suitable manner. Similarly, video streaming software 656 is provided to decode and convert an input stream of digital video packets to a video format that can be used by video interface 618 and displayed as video on the television's video display system 622. Such video streamer software may include, for example, an appropriate software codec for the video encoding, or such codec may form a part of the video interface 618.

Thus, in certain embodiments a television device consistent with the present invention has a television video display system. An addressable input is provided for receiving a videoconference video stream addressed to the input address. A user interface provides a user with an option to accept a videoconference video stream addressed to the addressable input. A video streamer accepts the videoconference video stream and converts the video stream to a format that can be displayed on the television video display system, if the user provides an input to the user interface that accepts the video stream. In certain embodiments, a television audio system receives a stream of audio associated with the video stream to produce sounds associated with the videoconference. In certain embodiments, a broadband modem is incorporated wherein the addressable input is an address of the broadband modem. The address can be, for example, at least one of an IP address and a MAC address. In certain embodiments, the user interface further prompts a user to activate a cellular telephone in order to use the cellular telephone to provide outbound audio and video transmissions.

Many variations will occur to those skilled in the art upon consideration of the present teachings. For example, the hardware incorporated in the television as depicted in FIG. 6, could equally well be separate hardware or could be integrated into a cable television or satellite set top box. In this case, the television interface to the modem or set top box can have it's own IP address and MAC address and be separately addressable. In such case, all reference to addressing a call to the television should be interpreted to mean that the call is ultimately addressed to the television connection in order to view the video stream. Since the back channel 158 is used mostly for control, this could be implemented using an asymmetrical communication system, or using a separate dial-up connection with the video stream being provided over a broadband connection. Also, the term “cellular telephone” and similar terms are intended to embrace all technologies for wireless telephone communication including, for example, analog, TDMA, FDMA, CDMA, PCS and other current and future technologies without limitation.

Those skilled in the art will recognize, upon consideration of the above teachings, that certain of the above exemplary embodiments are based upon use of a programmed processor such as 604 and/or a processor within a cellular telephone and/or a processor at the service provider. However, the invention is not limited to such exemplary embodiments, since other embodiments could be implemented using hardware component equivalents such as special purpose hardware and/or dedicated processors. Similarly, general purpose computers, microprocessor based computers, micro-controllers, optical computers, analog computers, dedicated processors, application specific circuits and/or dedicated hard wired logic may be used to construct alternative equivalent embodiments.

Those skilled in the art will appreciate, upon consideration of the above teachings, that the program operations and processes and associated data used to implement certain of the embodiments described above can be implemented using disc storage as well as other forms of storage such as for example Read Only Memory (ROM) devices, Random Access Memory (RAM) devices, network memory devices, optical storage elements, magnetic storage elements, magneto-optical storage elements, flash memory, core memory and/or other equivalent volatile and non-volatile storage technologies without departing from certain embodiments of the present invention. Such alternative storage devices should be considered equivalents.

Certain embodiments described herein, are or may be implemented using a programmed processor, such as 604 and/or a processor within a cellular telephone and/or a processor at the service provider, executing programming instructions that are broadly described above in flow chart form that can be stored on any suitable electronic or computer readable storage medium and/or can be transmitted over any suitable electronic communication medium. However, those skilled in the art will appreciate, upon consideration of the present teaching, that the processes described above can be implemented in any number of variations and in many suitable programming languages without departing from embodiments of the present invention. For example, the order of certain operations carried out can often be varied, additional operations can be added or operations can be deleted without departing from certain embodiments of the invention. Error trapping can be added and/or enhanced and variations can be made in user interface and information presentation without departing from certain embodiments of the present invention. Such variations are contemplated and considered equivalent.

While certain embodiments herein were described in conjunction with specific circuitry that carries out the functions described, other embodiments are contemplated in which the circuit functions are carried out using equivalent software or firmware embodiments executed on one or more programmed processors. General purpose computers, microprocessor based computers, micro-controllers, optical computers, analog computers, dedicated processors, application specific circuits and/or dedicated hard wired logic and analog circuitry may be used to construct alternative equivalent embodiments. Other embodiments could be implemented using hardware component equivalents such as special purpose hardware and/or dedicated processors.

Software and/or firmware embodiments may be implemented using a programmed processor executing programming instructions that in certain instances are broadly described above in flow chart form that can be stored on any suitable electronic or computer readable storage medium (such as, for example, disc storage, Read Only Memory (ROM) devices, Random Access Memory (RAM) devices, network memory devices, optical storage elements, magnetic storage elements, magneto-optical storage elements, flash memory, core memory and/or other equivalent volatile and non-volatile storage technologies) and/or can be transmitted over any suitable electronic communication medium. However, those skilled in the art will appreciate, upon consideration of the present teaching, that the processes described above can be implemented in any number of variations and in many suitable programming languages without departing from embodiments of the present invention. For example, the order of certain operations carried out can often be varied, additional operations can be added or operations can be deleted without departing from certain embodiments of the invention. Error trapping can be added and/or enhanced and variations can be made in user interface and information presentation without departing from certain embodiments of the present invention. Such variations are contemplated and considered equivalent.

While certain illustrative embodiments have been described, it is evident that many alternatives, modifications, permutations and variations will become apparent to those skilled in the art in light of the foregoing description.

What is claimed is:

1. A videoconference system, comprising;
a camera-enabled wireless telephone that transmits video images to a remote location using the telephone's camera and transmits audio signals to the remote location using the telephone's audio circuits;
wherein the transmission of audio and video signals to the remote location is carried out by first transmitting the audio and video signals over a telephone network to a telephone service provider;
wherein the telephone service provider converts the received video and audio signals to streaming audio and video;
wherein the telephone service provider further transmits the streaming audio and video via a broadband network connection; and
a television capable of receiving the streaming audio and video, and displaying the received streaming video and playing the streaming audio received via the broadband network connection.

2. The videoconference system according to claim 1, further comprising an audio circuit within the television, and wherein the streaming audio is reproduced on the television's audio circuitry.

3. The videoconference system according to claim 1, wherein the wireless telephone comprises a cellular telephone.

4. (canceled)

5. The videoconference system according to claim 1, wherein the broadband network connection is provided via one of a cable modem or a Digital Subscriber Line (DSL) modem or an Integrated Services Digital Network (ISDN) modem, or a high speed analog modem, or a digital telephone line adapter.

6. A videoconference system, comprising:
a camera-enabled wireless cellular telephone that transmits video images to a remote location using the telephone's camera and transmits audio signals to the remote location using the telephone's audio circuits;
wherein the transmission of audio and video signals to the remote location is carried out by first transmitting the audio and video signals over a wireless cellular telephone network to a telephone service provider;
wherein the telephone service provider converts the received video and audio signals to streaming audio and video:
wherein the telephone service provider further transmits the streaming audio and video via a broadband network connection;
a television capable of display of streaming video from the remote location via a broadband network connection to the cellular telephone service provider; and
an audio circuit within the television, and wherein the streaming video from the remote location includes audio, and wherein the audio is reproduced on the television's audio circuitry, and
wherein the broadband network connection is provided via one of a cable modem or a Digital Subscriber Line (DSL) modem or an Integrated Services Digital Network (ISDN) modem, or a high speed analog modem, or a digital telephone line adapter.

7. A videoconferencing method, comprising:
receiving a video stream via a broadband network connection at a television display to display a remote party's inbound video information, wherein the remote party transmits the video stream first to a wireless telephone service provider that streams the video to the television display over the broadband network; and
transmitting a video stream from a wireless telephone's camera to the remote party to provide outbound video information, wherein the transmission of the video stream to the remote party is carried out by first transmitting the video stream over a wireless telephone network to a wireless telephone service provider that streams the video to the remote party via the broadband network connection.

8. The videoconferencing method according to claim 8, further comprising receiving inbound audio from the remote party via the broadband network connection at the television display and playing the audio using the television display's audio circuits.

9. The videoconferencing method according to claim 8, further comprising transmitting outbound audio to the remote party via the wireless telephone's audio circuits.

10. The videoconferencing method according to claim 8, wherein the wireless telephone comprises a cellular telephone.

11. The videoconferencing method according to claim 8, wherein the streaming video is streamed to the television from a cellular telephone service provider.

12. The videoconferencing method according to claim 8, wherein the broadband network connection is provided via one of a cable modem or a Digital Subscriber Line (DSL) modem or an Integrated Services Digital Network (ISDN) modem, or a high speed analog modem, or a digital telephone line adapter.

13. A videoconferencing method, comprising:
receiving a video stream via a broadband network connection at a television display to display a remote party's inbound video information;
transmitting a video stream via a wireless cellular telephone's camera to the remote party to provide outbound video information, wherein the transmission of the video stream to the remote party is carried out by first transmitting the video stream over a cellular telephone network to a cellular telephone service provider that streams the video to the remote party via the broadband network connection;
receiving inbound audio from the remote party via the broadband network connection at the television display and playing the audio using the television display's audio circuits; and
transmitting outbound audio to the remote party via the wireless cellular telephone's audio circuits, wherein the transmission of the outbound audio to the remote party is carried out by first transmitting the outbound audio over the cellular telephone network to the cellular telephone service provider that streams the outbound audio to the remote party via the broadband network connection.

14. (canceled)

15. The videoconferencing method according to claim 13, wherein the broadband network connection is provided via one of a cable modem or a Digital Subscriber Line (DSL) modern or an Integrated Services Digital Network (ISDN) modem, or a high speed analog modem, or a digital telephone line adapter.

16. A method for receiving a videoconference call, comprising:
receiving a video telephone call from a calling party over a camera-enabled cellular telephone, in which the camera is used as a source of video to the calling party, and an audio circuit of the cellular telephone is used as a source of audio to the calling party, wherein the transmission of the audio and video from the calling parry is first transmitted over the cellular telephone network to a cellular telephone service provider that streams the audio and video to a broadband network connection;
receiving a broadband stream of video via the broadband network connection at a television display in order to display video from the calling party.

17. The method according to claim 16, further comprising receiving the inbound audio stream from the calling party via the broadband network connection at the television display and playing the audio using the television display's audio circuits.

18. A method of receiving a videoconference call from a calling party, comprising:
receiving a video telephone call over a camera-enabled cellular telephone over a cellular telephone network;
at the cellular telephone, accepting the video telephone call;
at a television display, receiving a call over a broadband connection;
at the television display, accepting the call over the broadband network to enable receipt of a video stream;
receiving the video stream via the broadband network at the television display to display the calling party's inbound video information;
transmitting a video stream via the a cellular telephone's camera to the calling party, wherein the transmission of the video stream is carried out by first transmitting the video stream over the cellular telephone network to a cellular telephone service provider that sends the video stream to a broadband connection for receipt by the calling parry; and
transmitting outbound audio to the remote party via the cellular telephone's audio circuits, wherein the transmission of the outbound audio is carried out by fist transmitting the outbound audio as a stream to the broadband connection for receipt by the calling party.

19. The method according to claim 18, further comprising receiving inbound audio from the calling party via the broadband network connection at the television display and playing the audio using the television display's audio circuits.

20. (canceled)

21. The method according to claim 18, wherein the broadband connection is provided via one of a cable modern or a Digital Subscriber Line (DSL) modem or an Integrated Services Digital Network (ISDN) modem, or a high speed analog modem, or a digital telephone line adapter.

22-26. (canceled)
